(19) United States
(12) Patent Application Publication
(10) Pub. No.: US 2015/0247505 A1
(43) Pub. Date: Sep. 3, 2015

(54) TEMPERATURE SENSING AND CONTROLLING SYSTEM FOR ELECTRONIC DEVICE

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: PENG ZHANG, Wuhan (CN); YU-LIN LIU, Wuhan (CN)

(21) Appl. No.: 14/524,785

(22) Filed: Oct. 27, 2014

(30) Foreign Application Priority Data
Feb. 28, 2014 (CN) 201410070767.1

(51) Int. Cl. F04D 27/00; G05B 15/02

(52) U.S. Cl. CPC F04D 27/004; G05B 15/02

(57) ABSTRACT

A temperature sensing and controlling system includes a temperature sensing module, a fan rotating speed, a display module, and a second control module. The temperature sensing module is configured to sense an actual temperature value inside the electronic device. The first control module is coupled to the temperature sensing module and is configured to control a rotating speed of a fan of the electronic device according to the sensed actual temperature value. The second control module is coupled to the display module and is configured to drive the display module to display the sensed actual temperature value according to a control signal output by the temperature sensing module.

### CROSS-REFERENCE TO RELATED APPLICATIONS

This application claims priority to Chinese Patent Application No. 201410070767.1 filed on Feb. 28, 2014, the contents of which are incorporated by reference herein.

### FIELD

The subject matter herein generally relates to a temperature sensing.

### BACKGROUND

Electronic devices, such as computers, server, and so on, include a plurality of electronic components. The plurality of electronic components will generate a plurality of heat.

### BRIEF DESCRIPTION OF THE DRAWINGS

Implementations of the present technology will now be described, by way of example only, with reference to the attached figures.

FIG. 1 is a block diagram of one embodiment of a temperature sensing and controlling system.

FIG. 2 is a detailed circuit of the temperature sensing and controlling system.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

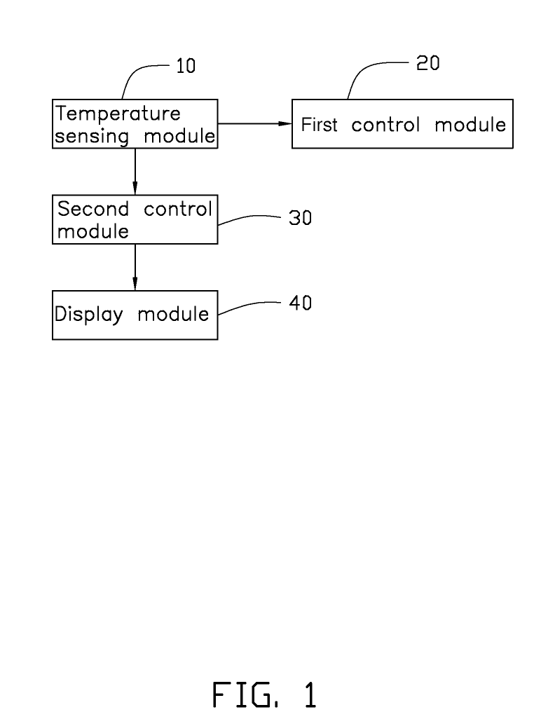

FIG. 1 illustrates a temperature sensing and controlling system for an electronic device in accordance with one embodiment. The temperature sensing and controlling system can include a temperature sensing module 10, a first control module 20, a second control module 30, and a display module 40.

The temperature sensing module 10 can sense an actual temperature value of the electronic device. The first control module 20 can control a rotating speed of a fan according to the sensed actual temperature value. For example, when the actual temperature value is greater than a preset temperature value, the first control module 20 can increase rotating speed. When the actual temperature value is less than the preset temperature value, the first control module 20 can decrease rotating speed. The second control module 30 can drive the display module 40 to display the sensed actual temperature value.

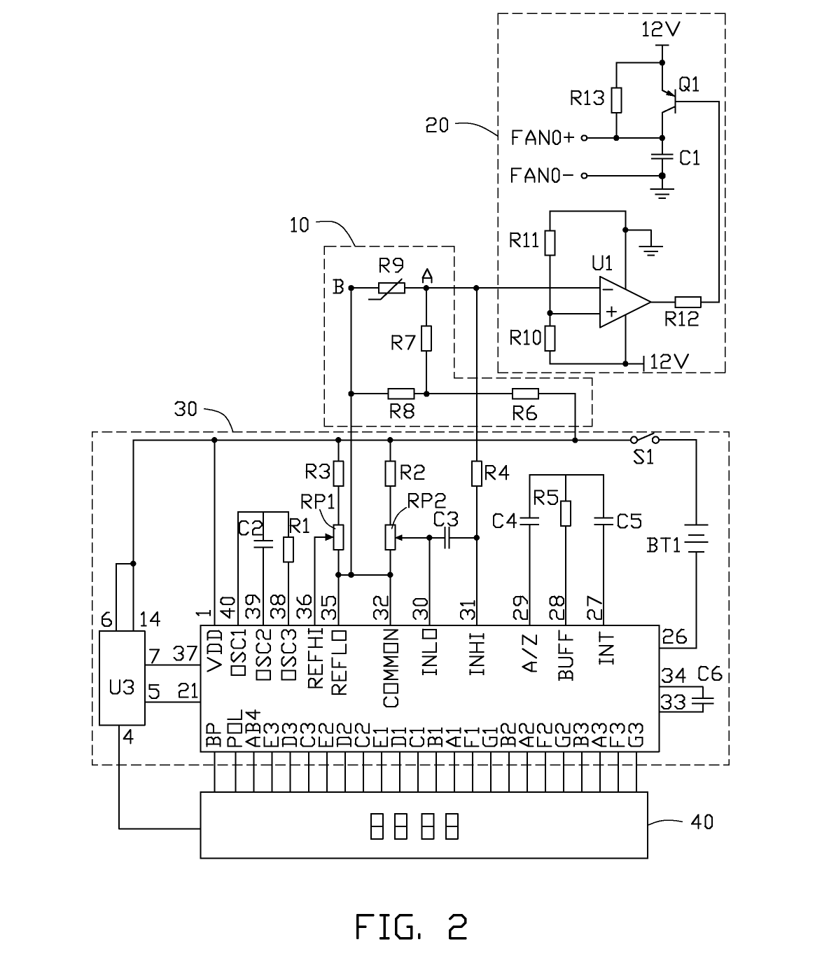

FIG. 2 illustrates that the temperature sensing module 10 can include a thermistor R9 and a plurality of resistors R6˜R8. A first terminal of the thermistor R9 is coupled to the second control module 30, and a second terminal of the thermistor R9 is coupled to the first control module 20. A first terminal of the resistor R6 is coupled to the second control module 30, and a second terminal of the resistor R6 is coupled to a first terminal of the resistors R7, R8. A second terminal of the resistor R7 is coupled to the first terminal of the thermistor R9, and a second terminal of the resistor R8 is coupled to the second terminal of the thermistor R9.

The first control module 20 can include a comparator U1, a transistor Q1, a capacitor C1, and a plurality of resistors R10˜R13. A negative terminal of the comparator U1 is coupled to the first terminal of the thermistor R9. A positive terminal of the comparator U1 is coupled to a working voltage via a resistor R10 and is grounded via a resistor R11. An output terminal of the comparator U1 is coupled to a base terminal of the transistor Q1. A collector terminal of the transistor Q1 is coupled to the working voltage and is coupled to a positive terminal of the fan. An emitter terminal of the transistor Q1 is coupled to a first terminal of the capacitor C1, and a second terminal of the capacitor C1 is grounded and is coupled to a negative terminal of the fan. The first control module 20 can send a control signal to control the speed of the fan.

The second control module 30 can include a driving chip U2, a plurality of resistors R1˜R5, a first rheostat RP1, a second rheostat RP2, a capacitors C2˜C6, and a logic element U3. In at least one embodiment, the driving chip U2 is an ICL706 chip, and the logic member U3 is a CD4030. A first terminal of the capacitor C2 is coupled to an OSC1 pin of the driving chip U2 and is coupled to a first terminal of the resistor R1, and a second terminal of the capacitor C2 is coupled to an OSC2 pin of the driving chip U2. A second terminal of the resistor R1 is coupled to an OSC3 of the driving chip U2. A movement terminal of the first rheostat RP1 is coupled to a REFHI pin of the driving chip U2. A first terminal of the first rheostat RP1 is coupled to a REF LO pin of the driving chip U2 and is coupled to a first terminal of the second rheostat RP2, and a second terminal of the rheostat RP1 is coupled to a first terminal of the resistor R3. A second terminal of the resistor R3 is coupled to a VDD pin of the driving chip U2 and is coupled to a positive terminal of a battery BT1 via a switch S1. The first terminal of the second rheostat RP2 is coupled to a COMMON pin of the driving chip U2, and a second terminal of the second rheostat RP2 is coupled to a first terminal of the resistor R2. A second terminal of the resistor R2 is coupled to the second terminal of the resistor R3. A movement terminal of the second rheostat RP2 is coupled to a INLO pin of the driving chip U2 and a first terminal of the capacitor C3, and a second terminal of the capacitor C3 is coupled to a INHI pin of the driving chip U2 and is coupled to the first terminal of the thermistor R9 via a resistor R4. First terminals of the capacitor C4, the resistor R5 and the capacitor C5 are respectively coupled to A/Z, BUFF, INT pins of the driving chip U2. The driving chip U2 can include twenty-four pins connected to the display module 40 and can send a control signal to the display module 40, to display the sensed actual temperature value.

The logic element U3 is coupled to the driving chip U1 and the display module 40. The logic element U3 can control a decimal point of data displayed by the display module.

In practice, when the thermistor R9 senses the actual temperature value greater than the preset temperature value, the resistance of the thermistor R9 increases. The potential of the first terminal of the thermistor R9 increases. The output terminal of the comparator U1 can output low-logic level to the transistor Q1, and the transistor Q1 is switched on so that the voltage of the capacitor C1 become great. The rotating speed of the fan will increase to drop the temperature of the electronic device.

When the thermistor R9 senses the actual temperature value smaller than the preset temperature value, the resistance of the thermistor R9 decreases. The potential of the first terminal of the thermistor R9 decreases. The output terminal of the comparator U1 can output high-logic level to the transistor Q1, and the transistor Q1 is switched off so that the voltage of the capacitor C1 become small. The rotating speed of the fan will decrease.

In addition, the potential of the second terminal of the thermistor R9 will change. The driving chip U2 can drive the display module 40 to display corresponding temperature value according to the potential of the second terminal of the thermistor R9. In at least one embodiment, a linear relationship is between the potential of the second terminal of the thermistor R9.

The embodiments shown and described above are only examples. Many details are often found in the art such as the other features of a temperature sensing and controlling system. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims. It will therefore be appreciated that the embodiments described above may be modified within the scope of the claims.

What is claimed is:

1. A temperature sensing and controlling system for an electronic device comprising:
a temperature sensing module configured to sense an actual temperature value of the electronic device;
a first control module coupled to the temperature sensing module and configured to control a rotating speed of a fan of the electronic device according to the sensed actual temperature value;
a display module; and
a second control module coupled to the display module and configured to drive the display module to display the sensed actual temperature value according to a control signal output by the temperature sensing module.

2. The temperature sensing and controlling system of claim 1, wherein the temperature sensing module comprises a thermistor, a first terminal of the thermistor is coupled to the first control module, and a second terminal of the thermistor is coupled to the second control module.

3. The temperature sensing and controlling system of claim 2, wherein the thermistor is a linear thermistor.

4. The temperature sensing and controlling system of claim 2, wherein the first control module comprises a comparator and a transistor, a negative terminal of the comparator is coupled to the first terminal of the thermistor, a positive terminal of the comparator is coupled to a power supply, and an output terminal of the thermistor is coupled to a base terminal of the transistor.

5. The temperature sensing and controlling system of claim 4, wherein the first control module further comprises a capacitor, a first terminal of the capacitor is coupled to a collector terminal of the transistor, and a second terminal of the capacitor is grounded; an emitter terminal of the transistor is coupled to the power supply; the first control module comprises two output ends, and the two output ends are respectively coupled to the first terminal and the second terminal of the capacitor.

6. The temperature sensing and controlling system of claim 4, wherein the transistor is a NPN transistor.

7. The temperature sensing and controlling system of claim 2, wherein the second control module comprises a driving chip, and the driving chip is coupled to the second terminal.

8. The temperature sensing and controlling system of claim 7, wherein the second control module further comprises a first rheostat, the first rheostat is coupled to the driving chip and the second terminal.

9. The temperature sensing and controlling system of claim 7, wherein the second control module further comprises a second rheostat, the second rheostate is coupled to the driving chip and the second terminal.

10. The temperature sensing and controlling system of claim 7, wherein the second control module further comprises a logic device, and the logic device is configured to control the decimal point of data displayed by the display module.

11. A temperature sensing and controlling system for an electronic device comprising:
a temperature sensing module comprising a thermistor, and the thermistor being configured to sense an actual temperature value inside the electronic device;
a first control module comprising a comparator, the comparator being coupled to the thermistor and a fan of the electronic device, the thermistor being configured to control a rotating speed of the fan of the electronic device according to the sensed actual temperature value;
a display module; and
a second control module coupled to the display module and configured to drive the display module to display the sensed actual temperature value according to signal output by the temperature sensing module.

12. The temperature sensing and controlling system of claim 11, wherein a first terminal of the thermistor is coupled to the first control module, and a second terminal of the thermistor is coupled to the second control module.

13. The temperature sensing and controlling system of claim 12, wherein the thermistor is a linear thermistor.

14. The temperature sensing and controlling system of claim 12, wherein the first control module comprises a comparator and a transistor, a negative terminal of the comparator is coupled to the first terminal of the thermistor, a positive terminal of the comparator is coupled to a power supply, and an output terminal of the thermistor is coupled to a base terminal of the transistor.

15. The temperature sensing and controlling system of claim 14, wherein the first control module further comprises a capacitor, a first terminal of the capacitor is coupled to a collector terminal of the transistor, and a second terminal of the capacitor is grounded; an emitter terminal of the transistor is coupled to the power supply; the first control module comprises two output ends, and the two output ends are respectively coupled to the first terminal and the second terminal of the capacitor.

16. The temperature sensing and controlling system of claim 14, wherein the transistor is a NPN transistor.

17. The temperature sensing and controlling system of claim 12, wherein the second control module comprises a driving chip, and the driving chip is coupled to the second terminal.

18. The temperature sensing and controlling system of claim 17, wherein the second control module further comprises a first rheostat, the first rheostat is coupled to the driving chip and the second terminal.

19. The temperature sensing and controlling system of claim 17, wherein the second control module further comprises a second rheostat, the second rheostate is coupled to the driving chip and the second terminal.

20. A temperature monitoring and control system for an electronic device comprising:
a temperature sensing module positioned to sense temperature related to a monitored electronic device;
a first control module;
a display module; and
a second control module;
wherein, the temperature sensing module is connected to the first control module and provides input to the first control module;
wherein, the first control module is connectable to an electronic device temperature adjusting device to control the electronic device temperature adjusting device based on the input from the temperature sensing module;
wherein, the temperature sensing module is connected to the second control module and provides input to the second control module;
wherein, the second control module is connected to the display module and provides output to the display module based on input from the temperature sensing module; and
wherein, the display module displays the temperature sensed by the temperature sensing module based on the input from the second control module.
